(19) United States
(12) Patent Application Publication
(10) Pub. No.: US 2009/0079622 A1
(43) Pub. Date: Mar. 26, 2009

(54) SHARING OF GPS INFORMATION BETWEEN MOBILE DEVICES

(75) Inventors: Nambirajan Seshadri, Irvine, CA (US); Jeyhan Karaoguz, Irvine, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/026,582

(22) Filed: Feb. 6, 2008

Related U.S. Application Data
(60) Provisional application No. 60/975,422, filed on Sep. 26, 2007.

(51) Int. Cl. G01S 1/00; G01C 21/00

(52) U.S. Cl. 342/357.1; 701/213

(57) ABSTRACT

Mobile radio devices with Global Positioning System (GPS) receivers are able to share GPS information through a wireless communication connection. When one mobile radio device acquires GPS information associated with positioning of that mobile radio device, the mobile radio device can establish a communication connection with another mobile radio device via a wireless link to share that acquired GPS information with the other mobile radio device.

### CROSS REFERENCE TO RELATED PATENTS

The present U.S. Utility Patent Application claims priority pursuant to 35 U.S.C. §119(e) to the following U.S. Provisional Patent Application which is hereby incorporated herein by reference in its entirety and made part of the present U.S. Utility Patent Application for all purposes:

U.S. Provisional Application Ser. No. 60/975,422, entitled “Sharing of GPS Information Between Mobile Devices,” (Attorney Docket No. BP6427), filed Sep. 26, 2007, pending.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Technical Field of the Invention

This invention is related generally to GPS positioning of mobile devices, and more particularly to the use of GPS information related to GPS positioning of mobile devices.

2. Description of Related Art

The Global Positioning System (GPS) is a satellite-based navigation system made up of a network of 24 satellites placed into orbit by the U.S. Department of Defense. GPS was originally intended for military applications, but in the 1980s, the government made the system available for civilian use. GPS satellites circle the earth twice a day in a very precise orbit and transmit GPS signals to earth. GPS receivers use this information to determine how far away a particular satellite is by comparing the time a signal was transmitted by that satellite with the time it was received. With distance measurements from three or more satellites and with knowledge of the current location-in-space of each satellite, the measured distances are used to envisage a respective sphere for each satellite that is centered on that satellite and has a radius equal to the measured distance to that satellite. The GPS receiver triangulates its current location by calculating the intersection between the spheres.

With four or more satellites in view, the GPS receiver can determine the user's 3D position (latitude, longitude and altitude). Once the user's position has been determined, the GPS unit can calculate other information, such as speed, bearing, track, trip distance, distance to destination, sunrise and sunset time and more. Thus, GPS has become a widely used aid for navigation purposes, and a useful tool for map-making, land surveying, commerce, and scientific uses. In addition, GPS also provides a precise time reference used in many applications.

Each GPS satellite continuously broadcasts what is commonly referred to as a navigation message that includes ephemeris data and almanac data. The ephemeris data gives the satellite's own precise orbit and is output over 18 seconds, repeating every 30 seconds. The ephemeris data is updated every 2 hours and is generally valid for 4 hours, with provisions for 6 hour time-outs. The almanac data includes coarse orbit and status information for each satellite in the constellation and takes 12 seconds for each satellite present, with information for a new satellite being transmitted every 30 seconds (15.5 minutes for 31 satellites). The purpose of the almanac data is to assist in the acquisition of satellites at power-up by allowing the receiver to generate a list of visible satellites based on stored position and time, while the ephemeris data from each satellite is needed to compute position fixes using that satellite.

However, the time needed to acquire the ephemeris data is becoming a significant element of the delay to first position fix. This is due to the fact that as even though the hardware is faster, and therefore, the time to lock onto the satellite signals is shrinking, the ephemeris data still takes up to 30 seconds to be received, due to the low data transmission rate. In addition, GPS devices are typically power intensive, and therefore, battery-powered mobile GPS devices may have a short battery life and/or may significantly drain the battery of a host device. Therefore, a need exists for more efficient mobile GPS devices.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram illustrating a GPS system that includes a plurality of GPS receivers and a plurality of GPS satellites, in accordance with the present invention;

FIG. 2 is a schematic block diagram illustrating an exemplary GPS receiver in accordance with the present invention;

FIG. 3 is a schematic block diagram illustrating exemplary wireless mobile radio devices incorporating GPS receivers for sharing GPS information therebetween in accordance with the present invention;

FIG. 4 is a schematic block diagram of an exemplary mobile radio device for sending and receiving GPS information to and from other mobile radio devices in accordance with the present invention;

FIG. 5 is a schematic diagram illustrating an exemplary automobile dashboard providing a user interface to an automobile navigation system that is capable of communicating GPS information with other nearby wireless mobile radio devices in accordance with the present invention; and

FIG. 6 is a logic diagram of a method for sharing GPS information between mobile radio devices in accordance with the present invention.

### DETAILED DESCRIPTION OF THE INVENTION

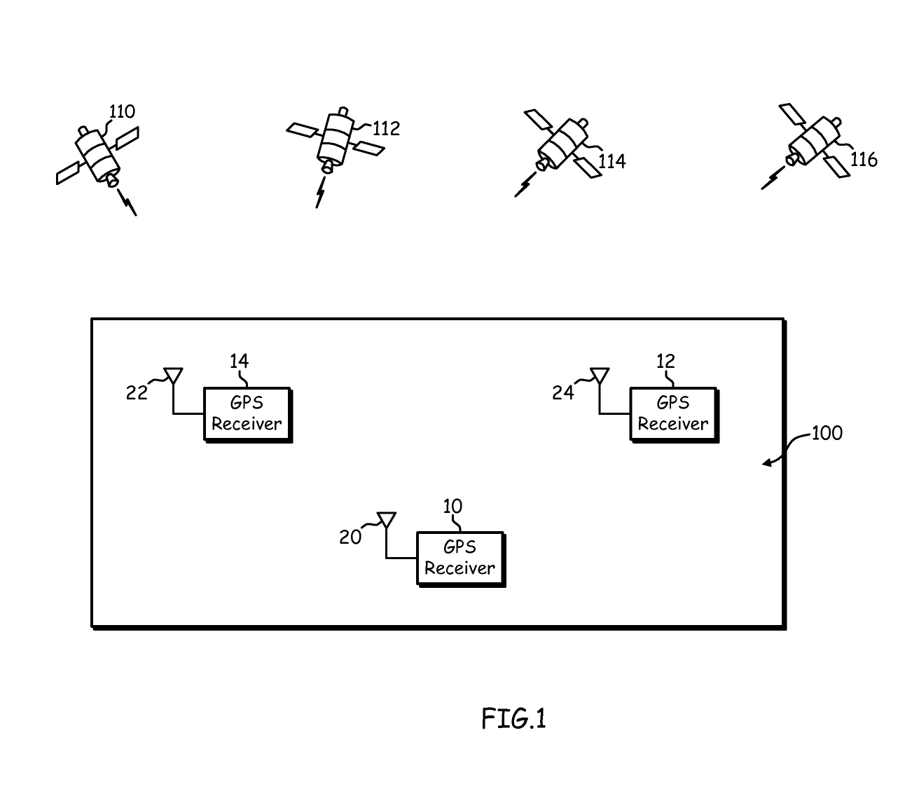

FIG. 1 is a schematic diagram illustrating an exemplary Global Positioning System (GPS) network. The GPS network includes GPS receivers 10, 12 and 14 and a plurality of GPS satellites 110, 112, 114 and 116. Each GPS receiver 10, 12 and 14 includes a respective GPS antenna 20, 22 and 24 and is capable of calculating a GPS location of the GPS receiver 10, 12 and 14 based on GPS satellite signals broadcast from the GPS satellites 110, 112, 114 and 116. The GPS receivers 10, 12 and 14 are located in an area 100 over which the individual satellite coverage areas for various GPS satellites 110, 112, 114 and 116 overlap. Therefore, GPS satellites 110, 112, 114 and 116 are “in view” of the GPS receivers 10, 12 and 14. Shown in FIG. 1 are four GPS satellites 110, 112, 114 and 116 that are in view of the GPS receivers 10, 12 and 14. However, in other embodiments, there may be more or less satellites in view of the GPS receivers 10, 12 and 14.

Each GPS satellite 110, 112, 114 and 116 transmits a respective navigation message that includes information used by the GPS receivers 10, 12 and 14 to calculate their geographical position (i.e., three-dimensional coordinates). For example, the navigation message transmitted by GPS satellite 110 includes a unique pseudorandom coarse/acquisition (C/A) code that identifies GPS satellite 110. The C/A code is a 1,023 bit long pseudorandom code that is broadcast at 1.023 MHz, repeating every millisecond. The navigation message further includes almanac data that provides coarse time information along with coarse orbital parameters for all of the GPS satellites in the GPS constellation and ephemeris data that contains precise orbital and clock correction parameters for GPS satellite 110. Although the almanac data is not precise, the data is current for up to several months, while the ephemeris data has a life span of only about five hours per satellite.

Typically, when a GPS receiver, e.g., GPS receiver 10, is turned on, the GPS receiver 10 has some almanac data, but little or no ephemeris data. The GPS receiver 10 uses the almanac and/or ephemeris data to determine which of the GPS satellites 110, 112, 114 and 116 should be in view and begins searching for these satellites 110, 112, 114 and 116. To acquire a signal from one of the GPS satellites (e.g., GPS satellite 110), the GPS receiver 10 generates a replica signal containing the C/A code for that satellite 110 and synchronizes (correlates) a phase and frequency of the replica signal to a phase and frequency of the GPS satellite signal broadcast by the GPS satellite 110. Since the broadcast GPS satellite signal travels at a known speed, the phase offset between the replica signal and the broadcast GPS satellite signal indicates the time delay between transmission and reception of the GPS satellite signal.

From the measured time delay, the pseudorange (distance) from the location of the GPS receiver 10 to the GPS satellite 110 can be calculated. The GPS receiver 10 further calculates the current precise location-in-space of the satellite 110 from the ephemeris data, and uses the location-in-space of the satellite 110 along with the pseudorange for that satellite 110 to calculate the geographical location of the GPS receiver 10. To achieve a high level of accuracy, the geographical location fix for the GPS receiver 10 is derived by solving four simultaneous equations having locations-in-space and pseudoranges for four or more GPS satellites 110, 112, 114 and 116.

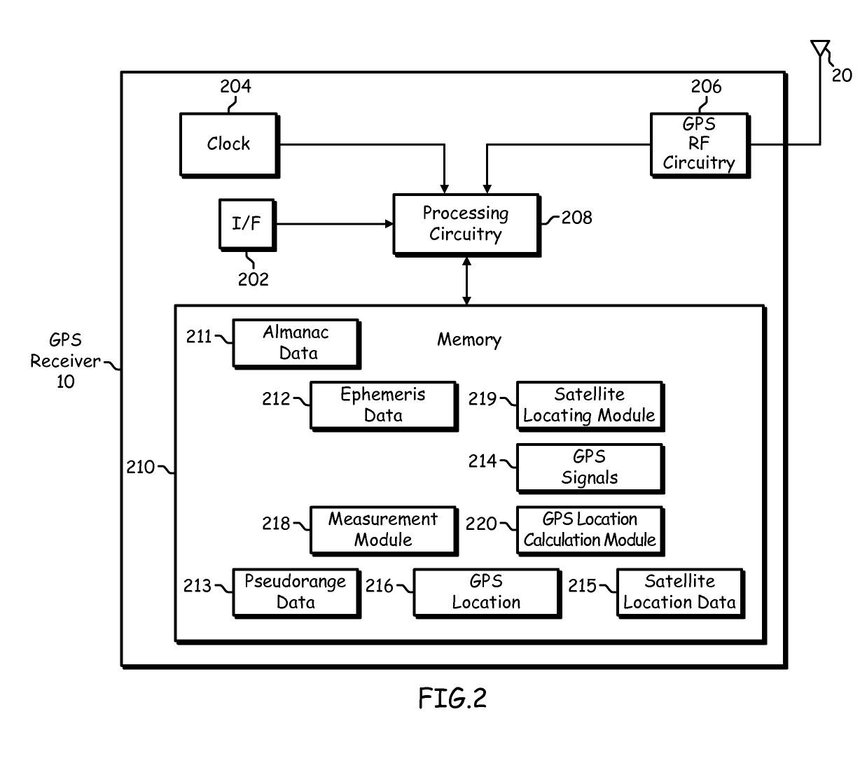

A more detailed description of the operation of the GPS receiver 10 will now be described with reference to FIG. 2. As shown in FIG. 2, the GPS receiver 10 includes an input/output (I/O) interface (I/F) 202, a GPS clock 204, GPS Radio Frequency (RF) circuitry 206, processing circuitry 208 and a memory 210. The processing circuitry 208 is communicatively coupled to the memory 210. The memory 210 stores, and the processing circuitry 208 executes, operational instructions corresponding to at least some of the functions illustrated herein. For example, in one embodiment, the memory 210 maintains a pseudorange measurement module 218, a satellite locating module 219 and a GPS location calculation module 220. The memory 210 further maintains various data used during the execution of one or more modules. For example, in one embodiment, the memory 210 maintains almanac data 211, ephemeris data 212, calculated pseudoranges 213, GPS signals 214 (e.g., received C/A codes and replica C/A codes for comparison therebetween), locations-in-space 215 of the satellites and one or more GPS location fixes 216.

The pseudorange measurement module 218 includes instructions executable by the processing circuitry 208 for measuring the pseudorange 213 from the GPS receiver 10 to a particular satellite using, for example, the almanac data 211, GPS signals 214 and a clock signal provided by the GPS clock 204. The satellite locating module 219 includes instructions executable by the processing circuitry 208 for determining the location-in-space of each satellite whose pseudorange is calculated by the pseudorange measurement module 218. The GPS location calculation module 220 includes instructions executable by the processing circuitry 208 for calculating the current GPS location of the GPS receiver 10 based on pseudoranges calculated by the pseudorange measurement module and the locations-in-space calculated by the satellite locating module 219. Thus, the pseudorange measurement module 218, satellite locating module 219 and GPS location calculation module 220 each provide respective instructions to the processing circuitry 208 during GPS positioning of the GPS receiver 10.

The processing circuitry 208 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 210 may be a single memory device or a plurality of memory devices. Such a memory device may be a read-only memory, random access memory, volatile memory, non-volatile memory, static memory, dynamic memory, flash memory, and/or any device that stores digital information. Note that when the processing circuitry 808 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In addition, as one of average skill in the art will appreciate, the GPS receiver 10 of FIG. 2 may be implemented using one or more integrated circuits. For example, the GPS RF circuitry 206 may be implemented on a first integrated circuit, while the processing circuitry 208 is implemented on a second integrated circuit. As an alternate example, the GPS RF circuitry 206 and processing circuitry 208 may be implemented on a single integrated circuit. Further, memory 210 may be implemented on the same integrated circuit as processing circuitry 208 or on a different integrated circuit.

In an exemplary operation, the processing circuitry 208 accesses the almanac data 211 to identify various satellites, preferably four or more satellites, that should be within view of the GPS receiver 10. The processing circuitry 208 selects one of the identified satellites for code searching and programs the GPS RF circuitry 206 to receive and process the carrier signal broadcast by the selected satellite. The GPS RF circuitry 206 receives a spread spectrum GPS signal broadcast simultaneously from multiple GPS satellites via antenna 20 and down-converts the desired carrier signal within the GPS signal to a frequency suitable for digital signal processing. The desired carrier signal is modulated with a GPS bit stream and spread by a pseudorandom C/A code sequence at a 1.023 MHz rate that is one millisecond long. The GPS RF circuitry 206 passes the down-converted GPS signal to the processing circuitry 208, which executes the pseudorange measurement module 218 to generate a GPS replica signal 214 for the satellite, despread the down-converted GPS signal by correlating the GPS replica signal 214 with the down-converted GPS signal using a clock signal generated by GPS clock 204 and produce a correlation signal indicative of the time delay of the down-converted GPS signal.

The pseudorange measurement module 218 further provides instructions to the processing circuitry 208 to calculate the pseudorange 213 from the GPS receiver 10 to the selected satellite based on the correlation signal. In addition, the processing circuitry 208 executes the satellite locating module 219 to process and store within the memory 210 the ephemeris data 212 included in the downconverted GPS signal and to calculate the precise location-in-space 215 of the selected satellite using the stored ephemeris data 212. This process is repeated for each satellite carrier signal selected by the processing circuitry 208 for processing thereof based on the almanac data 211.

Once the locations-in-space 215 and pseudoranges 213 of four or more satellites within view of the GPS receiver 10 have been determined, the processing circuitry executes the GPS location calculation module 220 to calculate the GPS location 216 of the GPS receiver 10.

However, the satellite searching process to lock onto and acquire four or more separate GPS signals can take several minutes, which may be undesirable in some situations. In addition, since the ephemeris data is broadcast over a 30 second cycle and re-transmitted every 30 seconds, the GPS receiver 10 requires a full 30 seconds of uninterrupted data reception to properly download the ephemeris data. If obstructions or reflections off of surrounding structures interrupt the data reception by the GPS receiver 10, such that the GPS receiver 10 loses track of the signal part way through the 30 second cycle, the GPS receiver 10 has to start the data reception process all over again at the next 30 second cycle, which can significantly increase the time to first GPS location fix. Moreover, some obstructions may prevent the GPS receiver 10 from receiving any type of signal altogether from one or more satellites in view of the GPS receiver 10. In addition, mobile GPS devices 10 may suffer from short battery life.

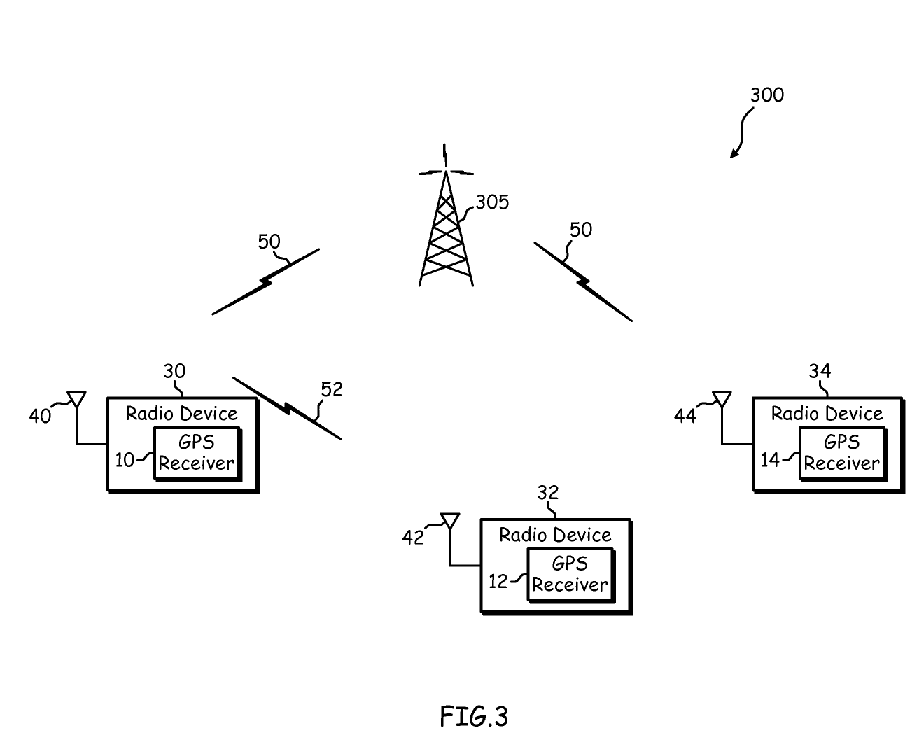

Therefore, as shown in FIG. 3, in accordance with embodiments of the present invention, the GPS receiver 10 can be included within a mobile radio device 30 that is operable to communicate with other mobile radio devices, e.g., devices 32 and 34, that include respective GPS receivers 12 and 14, via wireless links 52 and 50, respectively, to share GPS information therebetween. FIG. 3 illustrates a wireless communication system 300 that includes the mobile radio devices 30, 32 and 34 and one or more network components, such as a base station or access point (AP) 305. In FIG. 3, although not specifically shown, it is assumed that the mobile radio devices 30, 32 and 34 are within overlapping satellite coverage areas, such that any GPS information that may be shared between the mobile radio devices 30, 32 and 34 is relevant to the mobile radio devices 30, 32 and 34.

In addition, although not specifically shown, as is known in the art, the base station 305 may be coupled to a communications network, which may include one or more routers, switches, bridges, modems, system controllers, etc. Furthermore, the base station 305 has an associated antenna or antenna array to communicate with the mobile radio devices, e.g., devices 30 and 34, via respective antennas 40 and 44, within an area served by base station 305.

For example, mobile radio devices 30 and 34 may be cellular telephones that operate in accordance with one or more wireless communication standards (e.g., IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof). In order for cellular telephones 30 and 34 to communicate with each other, each registers with the base station or access point 305 to receive services from the wireless communication network, and a communication connection between the mobile devices 30 and 34 is established via base station 305 through respective wireless links 50.

The wireless communication system 300 is further capable of supporting direct connections (i.e., point-to-point communications) between mobile radio devices, e.g., devices 30 and 32. For example, mobile radio devices 30 and 32 may communicate directly with each other via respective antennas 40 and 42 via an allocated Bluetooth channel or other RF channel over wireless link 52. Regardless of the type of communication connection, once a connection is established between two mobile radio devices that each include a respective GPS receiver, in accordance with embodiments of the present invention, the mobile radio devices are able to share GPS information between them.

In an exemplary embodiment, the shared GPS information includes the calculated GPS location of one or more mobile radio devices 30, 32 and 34. For example, GPS receiver 10 can provide to GPS receiver 12 the calculated GPS location of GPS receiver 10 through the wireless communication link 52 between mobile radio device 30 and mobile radio device 32. Based on the time difference of arrival between the time that mobile radio device 30 sent the GPS location and the time that mobile radio device 32 received the GPS location, and potentially other positioning information (e.g., other network signals), mobile radio device 32 can estimate or approximate its location.

In another exemplary embodiment, the shared GPS information includes GPS clock information, almanac data, ephemeris data and/or other information that can be used to calculate the GPS location of the mobile radio devices 30, 32 and 34. For example, in one embodiment, the GPS information can include almanac data. For example, the GPS receiver 10 within mobile radio device 30 can receive current almanac data from another GPS receiver, e.g., GPS receiver 12, within another one of the mobile radio devices 32 to determine which satellites should be in view of the GPS receiver 10.

In another embodiment, the GPS information can include pseudorange data. For example, the GPS receiver 14 within mobile device 34 can receive pseudorange data for one or more satellites from GPS receiver 10 within mobile device 30. GPS receiver 14 can further receive and/or access current almanac data to determine the coarse location-in-space of one or more GPS satellites. Based on the time difference of arrival between the time that mobile device 32 sent the GPS information and the time the mobile device 30 received the GPS information, which can be used to estimate the distance between mobile device 34 and mobile device 20, as described above, and the almanac data, the GPS receiver 10 can approximate one or more pseudoranges for GPS receiver 10. Although such a GPS location fix may not be as accurate as using the actual C/A code and ephemeris data from the satellites, the time to first GPS fix can be reduced by solving for the pseudorange with data processing rather than signal processing.

In another embodiment, the received pseudorange data can be used to approximate the pseudorange for one or more satellites to reduce the error in the GPS location due to satellite signal blockage and/or weak satellite signals. For example, GPS receiver 10 can receive and/or access current almanac data to determine the coarse location-in-space of one or more GPS satellites whose signals are blocked or are weak and then use the received pseudorange data from another GPS receiver 12 to calculate approximate pseudoranges from the GPS receiver 10 to those GPS satellites. It should be understood that these are only a few examples of the type of GPS information and use thereof that can be shared between mobile radio devices incorporating GPS receivers, and the present invention is not limited to any particular type or use of shared GPS information.

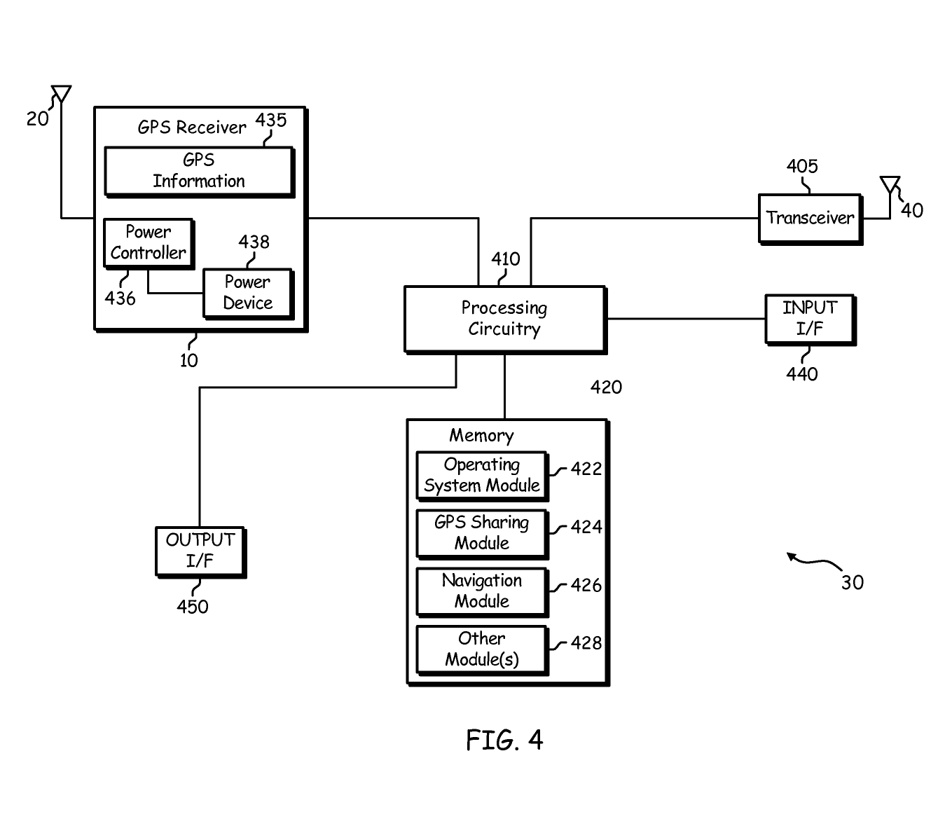

FIG. 4 is a schematic block diagram of an exemplary mobile radio device 30 for sending and receiving GPS information to and from other mobile radio devices in accordance with the present invention. As shown in FIG. 4, the mobile radio device 30 includes an RF transceiver 405 coupled to an RF antenna 40, a GPS receiver 10 coupled to a GPS antenna 20, processing circuitry 410, memory 420, an input interface (I/F) 440 and an output I/F 450. Although two separate antennas 20 and 40 are shown, it should be understood that in exemplary embodiments, a single antenna is provided that couples to both the RF transceiver 405 and the GPS receiver 10.

The GPS receiver 10 maintains GPS information 435 related to the positioning of the GPS receiver 10, and further includes a power controller 436 and power device 438. the RF transceiver 405 is coupled to send and receive RF signals to and from other mobile radio devices via either a direct connection or via a network connection. The input I/F 440 is coupled to an input device, e.g., a touch pad, stylus, numeric keypad or other input device, of the mobile radio device 30 to receive input or instructions from a user of the mobile radio device 30. The output I/F 450 is coupled to an output device, e.g., a display, speakers and/or other output device, of the mobile radio device 30 to provide output to the user of the mobile radio device 30.

The processing circuitry 410 is communicatively coupled to the GPS receiver 10, RF transceiver 405, input I/F 440, output I/F 450 and the memory 420. The memory 420 stores, and the processing circuitry 410 executes, operational instructions corresponding to at least some of the functions illustrated herein. For example, in one embodiment, the memory 410 maintains an operating system module 422, a GPS sharing module 424, a navigation module 426 and other modules 428. The operating system module 422 includes instructions executable by the processing circuitry 410 for operating the mobile radio device 30. The GPS sharing module 424 includes instructions executable by the processing circuitry 410 for sharing GPS information 435 between the GPS receiver 10 within the mobile radio device 30 and other GPS receivers within other mobile radio devices. The navigation module 426 includes instructions executable by the processing circuitry 410 for communicating with the GPS receiver 10 to receive a current GPS location of the mobile radio device 30 and for communicating with the input I/F 440 and output I/F 450 to receive and provide navigation information associated with the current GPS location to a user of the mobile radio device 30. The other modules 428 include instructions executable by the processing circuitry 410 to perform other functions of the mobile radio device 30. For example, such other modules 428 may include other navigation or location modules.

The processing circuitry 410 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 420 may be a single memory device or a plurality of memory devices. Such a memory device may be a read-only memory, random access memory, volatile memory, non-volatile memory, static memory, dynamic memory, flash memory, and/or any device that stores digital information. Note that when the processing circuitry 808 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In addition, as one of average skill in the art will appreciate, the mobile radio device 30 of FIG. 4 may be implemented using one or more integrated circuits. For example, the RF transceiver 405 may be implemented on a first integrated circuit, while the processing circuitry 410 is implemented on a second integrated circuit and the GPS receiver 10 is implemented on a third integrated circuit. As an alternate example, the GPS receiver 10 and processing circuitry 410 may be implemented on one integrated circuit, while the RF transceiver 405 is implemented on a second integrated circuit, or vice-versa. As yet another alternate example, the GPS receiver 10, RF transceiver 405 and processing circuitry 410 may all be implemented on a single integrated circuit. Further, memory 420 may be implemented on the same integrated circuit as processing circuitry 410 or on a different integrated circuit.

In an exemplary operation, the processing circuitry 410 initiates the GPS sharing module 424 either automatically or upon receiving an instruction from the user via the input I/F 440 to begin the process of sharing GPS information 435 with other mobile radio devices. For example, in one embodiment, when an incoming call from another mobile radio device is received via transceiver 405 that includes a request for GPS sharing, the processing circuitry 410 can either automatically initiate the GPS sharing module 424 or can provide the request to the user via output I/F and await instructions from the user via input I/F before initiating the GPS sharing module 424. In another embodiment, upon activation of the mobile radio device 30, the processing circuitry 410 can automatically attempt a call setup with another mobile radio device based on pre-programmed information and, upon establishing a connection, initiate the GPS sharing module 424. In yet another embodiment, the processing circuitry 410 can receive an instruction from the user of the mobile radio device 30 via input I/F to initiate the GPS sharing module 424 with another mobile radio device that already has a communication connection with the mobile radio device 30. In still another embodiment, the processing circuitry 410 can receive an instruction from the user of the mobile radio device via input I/F 440 to both establish a communication connection with another mobile radio device and initiate the GPS sharing module 424.

After initiating the GPS sharing module 424, the processing circuitry is able to either receive GPS information from another mobile radio device via the transceiver 405 and provide the GPS information to the GPS receiver 10 for use by the GPS receiver 10 or to retrieve stored GPS information 435 from the GPS receiver 10 and provide this retrieved GPS information to the other mobile radio device via the transceiver 405. As described above, such GPS information 435 can include a calculated GPS location, almanac data, ephemeris data, pseudorange data, GPS clock data and/or any other information that can be used to calculate the GPS location of the mobile radio devices. In embodiments in which the GPS sharing module 424 is initiated to receive GPS information from another mobile radio device, the GPS sharing module 424 may further provide instructions to the power controller 436 to turn off the power device 438 to the GPS receiver 10 to save the battery life of the GPS receiver 10 while another mobile radio device is actively operating their GPS receiver. For example, if the mobile radio device 30 is a cellular telephone that has a Bluetooth communication connection to an automobile navigation system that is operating to display navigation information to an operator of the automobile, the cellular telephone may turn off its GPS receiver 10 while the Bluetooth connection is active.

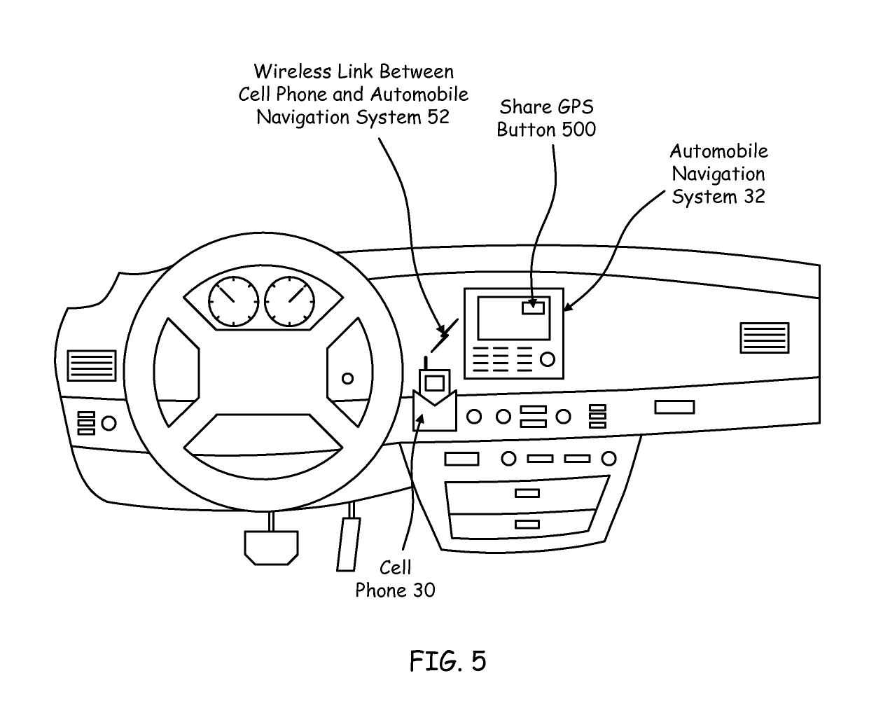

An exemplary scenario of GPS information sharing between mobile radio devices is shown in FIG. 5. FIG. 5 is a schematic diagram illustrating an exemplary dashboard of a vehicle providing a user interface to an automobile navigation system 32 resident within the vehicle. The automobile navigation system 32 is capable of communicating with other mobile radio devices within the vehicle. Specifically, in FIG. 5, a cellular telephone 30 is shown resident within the vehicle. The cellular telephone 30 has a direct communication connection, e.g., a Bluetooth connection, with the automobile navigation system 32 via wireless link 52.

In accordance with embodiments of the present invention, the automobile navigation system 32 and cellular telephone 30 are operable to share GPS information over the wireless link 52. When the operator of the vehicle turns on the ignition, thus turning on the automobile navigation system 32, the automobile navigation system 32 and/or the cellular telephone 30 can attempt to establish a communication connection with the other via wireless link 52. For example, in one embodiment, the automobile navigation system 32 can automatically attempt a call setup with the cellular telephone 30 based on pre-programmed information (i.e., telephone number and other information) associated with the cellular telephone. In another embodiment, the cellular telephone 30 and/or automobile navigation system 32 an attempt the call setup based on call setup information entered by the user into one of the devices.

Once the communication connection is established via wireless link 52, the automobile navigation system 32 or the cellular telephone can initiate sharing of GPS information. For example, in one embodiment, once the communication connection is established, the automobile navigation system 32 and the cellular telephone 30 can automatically begin sharing GPS information. In another embodiment, once the communication connection is established, the cellular telephone 30 or automobile navigation system 32 can receive an instruction from the user to initiate GPS information sharing. For example, the user can depress a share GPS button 500 on a navigation screen of the automobile navigation system 32. In an exemplary embodiment, while the automobile navigation system 32 is operating to calculate the GPS location of the vehicle and to display navigation information related to the calculated GPS location to the user, the cellular telephone 30 may turn off its GPS receiver to save battery life. In another exemplary embodiment, the automobile navigation system 32 may provide additional location information to the cellular telephone 30, such as the number of wheel revolutions of the vehicle that have occurred since the calculation of the GPS location. The wheel revolutions data can be used to calculate the distance the vehicle has traveled since the last GPS location fix.

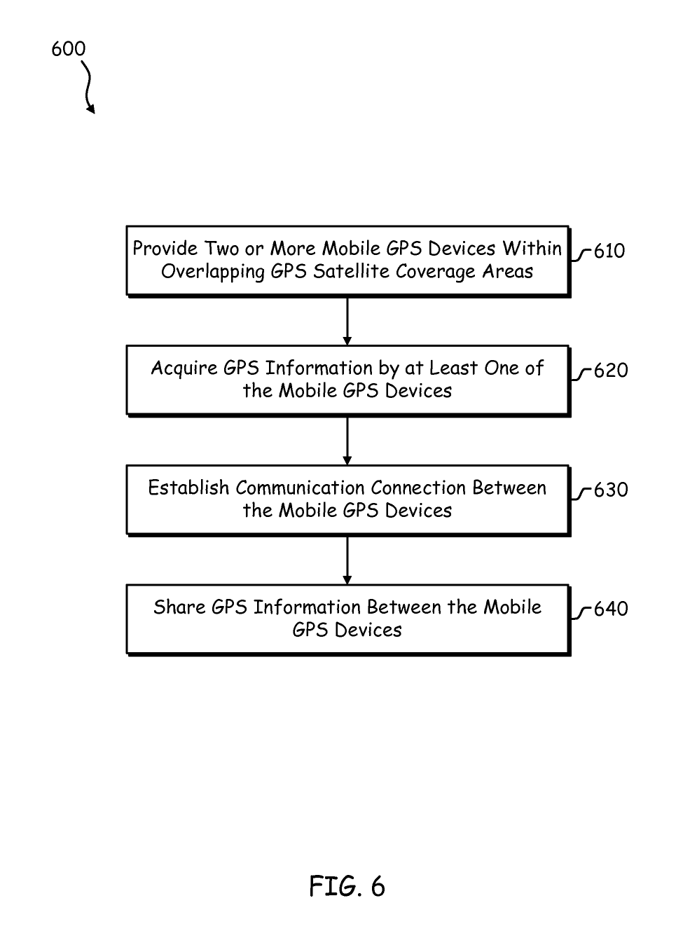

FIG. 6 is a logic diagram of a method 600 for sharing GPS information between mobile radio devices in accordance with the present invention. The process begins at step 610, where two or more mobile radio devices, each incorporating a GPS receiver, are located within overlapping GPS satellite coverage areas. The process continues at step 620, where GPS information is acquired by at least one of the mobile radio devices. For example, the GPS information can include GPS clock data, pseudorange data, ephemeris data, almanac data, calculated GPS location data and/or any other data related to GPS positioning. At step 630, a communication connection is established between two of the mobile radio devices. For example, the communication connection can be a direct communication connection using, e.g., Bluetooth, or an indirect communication connection via a wireless network, such as a Public Land Mobile Network (PLMN), Wireless Local Area Network (WLAN) or other network, using any available communication standard, such as IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof. At step 640, the process ends with GPS information being shared between the mobile radio devices. The shared GPS information may enable one of the mobile radio devices to reduce the time to first GPS location fix, improve the reliability of the calculated GPS location by receiving GPS information related to an obstructed GPS satellite and/or reduce or eliminate computational processing power, and thus increase battery life.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has further been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The preceding discussion has presented a radio device and method of operation thereof. As one of ordinary skill in the art will appreciate, other embodiments may be derived from the teaching of the present invention without deviating from the scope of the claims.

What is claimed is:

1. A mobile radio device, comprising:
a Global Positioning System (GPS) receiver operable to acquire GPS information associated with positioning of said mobile radio device;
a transceiver operable to establish a communication connection with an additional mobile radio device via a wireless link, said mobile radio device and said additional mobile radio device being located within overlapping GPS satellite coverage areas; and
processing circuitry coupled to said GPS receiver and said transceiver and operable to share said GPS information with said additional mobile radio device by providing said GPS information from said GPS receiver to said transceiver for transmission of said GPS information to said additional mobile radio device via said transceiver and said wireless link.

2. The mobile radio device of claim 1, further comprising:
an antenna coupled to receive a GPS signal including GPS data transmitted from at least one of a plurality of GPS satellites and to provide said GPS signal to said GPS receiver.

3. The mobile radio device of claim 2, wherein said GPS information includes said GPS data.

4. The mobile radio device of claim 2, wherein said GPS receiver is further operable to calculate a GPS location of said mobile radio device using said GPS data.

5. The mobile radio device of claim 4, wherein said GPS information includes said GPS location.

6. The mobile radio device of claim 1, wherein said GPS receiver further includes a memory maintaining almanac data indicating coarse orbital parameters for a plurality of GPS satellites, said GPS information including said almanac data.

7. The mobile radio device of claim 1, further comprising:
an input interface coupled to receive an input command from a user of said mobile radio device to initiate sharing of said GPS information with said additional mobile radio device.

8. The mobile radio device of claim 7, further comprising:
an output interface coupled to a display to display a share feature to the user, the selection of which by the user causing said input command to be provided to said input interface.

9. The mobile radio device of claim 1, wherein said processing circuitry is further operable to automatically detect said additional mobile radio device and to establish said communication connection with said additional mobile radio device for sharing of said GPS information therewith.

10. The mobile radio device of claim 1, wherein said mobile radio device is included within an automobile navigation system of a vehicle.

11. The mobile radio device of claim 10, wherein said additional mobile radio device is a wireless telephone within said vehicle and said communication connection is a Bluetooth connection.

12. The mobile radio device of claim 10, wherein said processing circuitry is further operable to provide additional location information to said additional mobile radio device.

13. The mobile radio device of claim 12, wherein said GPS information includes a calculated GPS location of said mobile radio device and said additional location information includes a number of wheel revolutions of said vehicle that occurred since the calculation of said GPS location corresponding to a distance traveled.

14. The mobile radio device of claim 1, wherein said processing circuitry is further operable to receive additional GPS information from said additional mobile radio device via said transceiver.

15. The mobile radio device of claim 14, wherein said GPS receiver further includes a power device operable to provide power to said GPS receiver and a power controller for controllably turning on and off said power device, and wherein said processing circuitry is further operable to instruct said power controller to turn off said power device upon receipt of said additional GPS information.

16. A method for sharing Global Positioning System (GPS) information between mobile radio devices within overlapping GPS satellite coverage areas, said method comprising:
acquiring GPS information associated with positioning of one of said mobile radio devices by said one of said mobile radio devices;
establishing a communication connection between said one of said mobile radio devices and an additional one of said mobile radio devices via a wireless link; and
sharing said GPS information with said additional one of said mobile radio devices via said wireless link.

17. The method of claim 16, wherein said acquiring further comprises:
receiving a GPS signal including GPS data transmitted from at least one of a plurality of GPS satellites; and
calculating a GPS location of said one of said mobile radio devices using said GPS data, wherein said GPS information includes one or more of said GPS data and said GPS location.

18. The method of claim 16, wherein said acquiring further comprises:
maintaining almanac data indicating coarse orbital parameters for a plurality of GPS satellites, said GPS information including said almanac data.

19. The method of claim 16, wherein said establishing said communication connection further comprises:
receiving a command from a user of said one of said mobile radio devices to initiate sharing of said GPS information with said additional one of said mobile radio devices.

20. The method of claim 16, wherein said establishing said communication connection further comprises:
automatically detecting said additional one of said mobile radio devices; and
automatically establishing said communication connection with said additional one of said mobile radio devices for sharing of said GPS information therewith.

21. The method of claim 16, wherein said establishing said communication connection further comprises:
establishing a Bluetooth connection between said one of said mobile radio devices and said additional one of said mobile radio devices.

22. The method of claim 16, further comprising:
providing additional location information to said additional one of said mobile radio devices.

23. The method of claim 16, further comprising:
receiving additional GPS information from said additional one of said mobile radio devices; and
turning off the power to a GPS receiver within said one of said mobile radio devices upon receipt of said additional GPS information.
